(19) United States
(12) Patent Application Publication
(10) Pub. No.: US 2023/0351159 A1
(43) Pub. Date: Nov. 2, 2023

(54) TRANSFORMER BOOSTED CAUSALITY RESPECTING PHYSICS INFORMED NEURAL NETWORKS

(71) Applicants: Dagnachew Birru, Marlborough, MA (US); Sofia P Moschou, Reading (GB); Shoumik Majumdar, Marlborough, MA (US); Rishi Yash Parekh, Mumbai (IN); Dhruv Mathew

(72) Inventors: Dagnachew Birru, Marlborough, MA (US); Sofia P Moschou, Reading (GB); Shoumik Majumdar, Marlborough, MA (US); Rishi Yash Parekh, Mumbai (IN); Dhruv Mathew

(73) Assignee: Quantiphi, Inc, Marlborough, MA (US)

(21) Appl. No.: 18/220,356

(22) Filed: Jul. 11, 2023

(51) Int. Cl. G06N 3/0455; G06N 3/084

(52) U.S. Cl. CPC G06N 3/0455; G06N 3/084

(57) ABSTRACT

A method and system for augmenting a neural network is provided herein. The method comprises connecting an input layer to a pre-input layer. The method further comprises joining a hidden layer to the input layer. The method comprises linking an output layer to the hidden layer. The method further comprises connecting a layer for computing physics equations to the output layer. The neural network system further comprising, an input layer, a hidden layer connected to the input layer and an output layer joined to the hidden layer. The system further comprising a layer for computing physics equations connected to the output layer and a pre-input layer attached to the input layer.

### TECHNICAL FIELD OF THE INVENTION

The present disclosure is related to method and system for providing a transformer boosted physics informed neural network.

### BACKGROUND OF THE INVENTION

Physics-informed neural networks (PINNs) are a class of machine learning algorithms that combine neural networks with physical principles to solve complex scientific and engineering problems. PINNs aim to leverage the power of deep learning while incorporating the governing laws of physics or other domain-specific constraints into the learning process.

In many scientific and engineering disciplines, physical laws govern the behavior of systems. These laws are typically expressed as differential equations or partial differential equations (PDEs) that describe how various quantities change in space and time. Solving these equations analytically can be challenging or even impossible for complex systems, leading to the need for numerical methods such as finite element methods or computational fluid dynamics.

PINNs offer an alternative approach to solving PDEs by training neural networks to approximate the solutions. The key idea is to incorporate the governing physics equations as constraints during the training process. By doing so, PINNs may leverage both data and domain knowledge, leading to more accurate and physically consistent predictions.

The training process of a PINN involves two main components: a neural network architecture and a loss function. The neural network architecture typically consists of multiple layers of interconnected neurons, enabling the network to learn complex mappings between inputs and outputs. The loss function is designed to enforce the physical constraints. It combines two types of terms: the data loss term, which measures the discrepancy between the predicted outputs and the available data, and the physics loss term, which quantifies the deviation from the governing equations.

To incorporate the physics constraints, the neural network is trained using gradient-based optimization methods, such as stochastic gradient descent. The gradients of the loss function with respect to the network parameters are computed using automatic differentiation. By iteratively adjusting the network parameters, the PINN aims to find a solution that satisfies both the observed data and the underlying physics equations.

One advantage of PINNs is their ability to learn from sparse and noisy data. Even when limited data points are available, PINNs can infer the underlying physical behavior and make predictions in regions where data may be lacking. This capability makes them particularly useful in scenarios where collecting extensive data sets is costly or impractical.

PINNs have found applications in various scientific and engineering fields, including fluid dynamics, solid mechanics, heat transfer, quantum mechanics, and many others. They have shown promise in areas such as surrogate modeling, inverse problems, control systems, and uncertainty quantification. Further, PINNs may be applied on time-series forecasting problems, for example in finance or other domains governed by nonlinear PDEs such as the Black-Scholes equation.

Overall, by combining the strengths of neural networks and physics-based modeling, PINNs offer a powerful framework for solving complex scientific problems while ensuring physical consistency and interpretability.

However, the present solutions for example lack with regards to enforcing causality and matching accuracy of physics equations.

It is within this context that the present embodiments arise.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide a method for augmenting a neural network, the method comprising connecting an input layer to a pre-input layer. The method may include joining a hidden layer to the input layer. The method may further include linking an output layer to the hidden layer. The method may also include connecting a layer for computing physics equations to the output layer.

According to some example embodiments, the neural network is an unsupervised learning neural network.

According to some example embodiments, wherein the pre-input layer is a transformer layer comprises encoders.

According to some example embodiments, the encoders further comprising a first encoder to handle time inputs.

According to some example embodiments, the encoders further comprising a second encoder to handle space inputs.

According to some example embodiments, the physics equations comprise at least a partial differential equation.

According to some example embodiments, the pre-input layer is a RNN

According to some example embodiments, the pre-input layer is a LSTM.

According to some example embodiments, the method further comprising processing data input to the input layer parallelly.

Some example embodiments disclosed herein provide a system for augmenting a neural network. The neural network further comprising an input layer, a hidden layer connected to the input layer and an output layer joined to the hidden layer. The system comprising a layer for computing physics equations connected to the output layer. The system further comprising a pre-input layer attached to the input layer.

Some example embodiments disclosed herein provide a non-transitory computer readable medium having stored thereon computer executable instruction which when executed by one or more processors, cause the one or more processors to carry out operations for augmenting a neural network. The operations comprising connecting an input layer to a pre-input layer. The operations further comprising joining a hidden layer to the input layer. The operations comprising linking an output layer to the hidden layer. The operations further comprising connecting a layer for computing physics equations to the output layer

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present disclosure will become apparent upon consideration of the following detailed description of embodiments thereof, especially when taken in conjunction with the accompanying drawings, and wherein:

FIG. 1 illustrates a block diagram for a physics informed neural network, in accordance with an example embodiment;

FIG. 2 illustrates a block diagram of an electronic circuitry for implementing a transformer boosted physics informed neural network, in accordance with an example embodiment;

FIG. 3 shows a block diagram an interface of a neural network with physics equation transformation, in accordance with an example embodiment;

FIG. 4 illustrates a block diagram the design of the transformer, in accordance with an example embodiment;

FIG. 5 shows a boundary conditions computation matrix, in accordance with an example embodiment;

FIG. 6 illustrates a boundary conditions computation matrix with joining condition, in accordance with an example embodiment;

FIG. 7 shows a block diagram the design of the transformer with pooling layer, in accordance with an example embodiment;

FIG. 8 shows a block diagram of an encoders' function, in accordance with an example embodiment;

FIG. 9 shows a flow diagram of a method for augmenting a neural network, in accordance with an example embodiment;

FIG. 10 shows a flow diagram of a method for operation of a transformer booster, in accordance with an example embodiment;

FIG. 11 illustrates a block diagram of a workflow of a transformer boosted PINNs, in accordance with an example embodiment;

FIG. 12 illustrates a block diagram of an autoregressive loop of a transformer boosted PINNs, in accordance with an example embodiment;

FIG. 13 illustrates a block diagram of a transformer architecture, in accordance with an example embodiment;

FIG. 14 illustrates a block diagram of a transformer boosted PINNs pertaining to inverse problem, in accordance with an example embodiment;

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The term “machine learning model” may be used to refer to a computational or statistical or mathematical model that is trained on classical ML modelling techniques with or without classical image processing. The “machine learning model” is trained over a set of data and using an algorithm that it may use to learn from the dataset.

The term “artificial intelligence” may be used to refer to a model built using simple or complex Neural Networks using deep learning techniques and computer vision algorithms. Artificial intelligence model learns from the data and applies that learning to achieve specific pre-defined objectives.

### End of Definitions

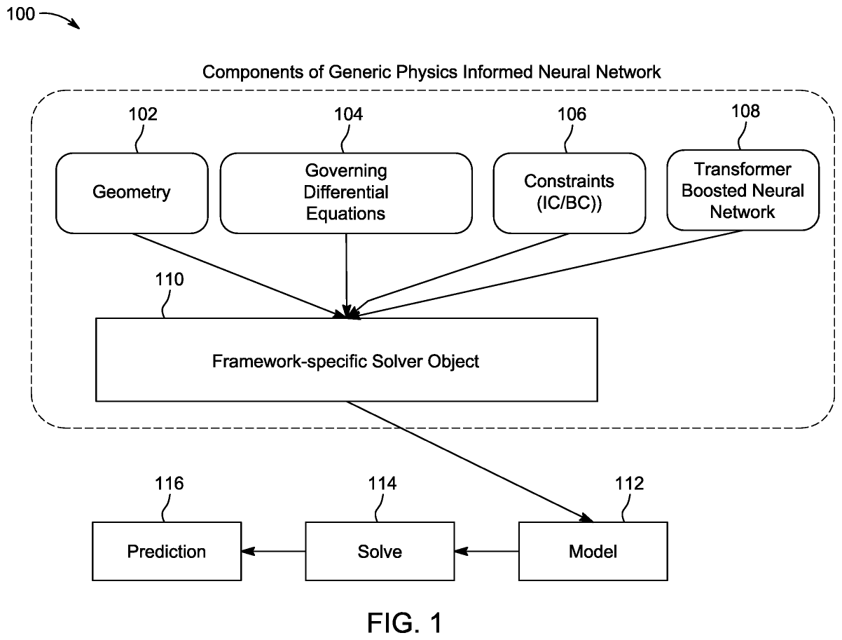

Embodiments of the present disclosure may provide a method, a system, and a computer program product for augmenting a neural network. The method, the system, and the computer program product for augmenting a neural network 1 are described with reference to FIG. 1 to FIG. 10 as detailed below.

FIG. 1 block diagram for a physics informed neural network, in accordance with an example embodiment. The physics-informed neural network (PINN) 100 is an enhanced version of the physics-informed neural network (PINN) framework that may incorporate transformer architecture to improve its performance in solving complex scientific and engineering problems.

The transformer architecture is a type of deep learning model that gained significant attention with its successful application in natural language processing tasks, particularly in machine translation tasks. Transformers excel in capturing long-range dependencies and effectively modeling sequential data. They achieve this through self-attention mechanisms that allow each element in a sequence to attend to all other elements, capturing the contextual relationships effectively.

In the context of PINNs, the addition of transformer architecture brings several advantages. By incorporating transformers, TB-PINNs 100 may better handle complex systems with long-range dependencies, such as those described by PDEs. The self-attention mechanism allows the network to capture interactions between different spatial locations or time steps, enabling more accurate modeling of the underlying physics.

The TB-PINN framework combines the transformer architecture with the traditional components of a PINN, including the neural network architecture and the incorporation of physics constraints. The neural network component of the TB-PINN 100 may be designed using fully connected layers or convolutional layers, depending on the problem's characteristics. The transformer layers are added to capture the long-range dependencies and improve the network's ability to learn complex spatial or temporal patterns.

During training, the TB-PINN 100 optimizes the network parameters using a combination of data loss and physics loss terms, similar to standard PINNs. The data loss term measures the discrepancy between the predicted outputs and the available data points. The physics loss term ensures that the learned solution satisfies the governing equations or physical constraints.

By incorporating transformer architecture, TB-PINNs may effectively learn from both sparse and noisy data while capturing the intricate dependencies present in the physical systems. This capability makes them particularly suitable for solving problems in fields such as fluid dynamics, solid mechanics, and other domains with complex dynamics and interactions.

Overall, TB-PINNs 100 leverage the strengths of both transformer architecture and physics-informed learning, allowing for more accurate and efficient solutions to complex scientific and engineering problems.

The TB-PINNs 100 comprise of a geometry 102. In an embodiment, geometry plays a fundamental and pivotal role in Physics-Informed Neural Networks (PINNs), enabling the accurate representation and understanding of physical systems. PINNs combine the flexibility and learning capabilities of neural networks with the constraints imposed by the governing equations of a system, making them powerful tools for solving partial differential equations (PDEs) and other physics-based problems. In this context, geometry influences various aspects of PINNs, each of which contributes to their significance in capturing the underlying physics.

Firstly, geometry encompasses the spatial domain in which the physical system is modeled. It defines the boundaries, interfaces, and shapes relevant to the problem at hand. The proper representation of geometry is crucial for accurately simulating and understanding the physics involved. By incorporating the geometric features of the system, PINNs provide a comprehensive and holistic representation that captures the physical reality.

Secondly, the geometry of the system determines the locations and characteristics of the boundary and initial conditions. These conditions play a crucial role in solving PDEs as they provide essential constraints and information about the system's behavior at specific points in space and time. The accuracy of the boundary and initial conditions directly affects the accuracy of the PINN solution. Geometry enables the precise definition and incorporation of these conditions, ensuring that the PINN captures the system's behavior in accordance with the physical laws governing it.

Thirdly, geometry guides the mesh generation process. Mesh generation involves discretizing the continuous domain into a collection of smaller elements such as triangles or quadrilaterals. This process facilitates numerical computations and enables the efficient implementation of the PINN. The quality and resolution of the mesh significantly impact the accuracy and efficiency of the PINN solution. Geometry guides the generation of an appropriate mesh that adequately represents the system's geometry, ensuring that the PINN can effectively capture the physical behavior of the system.

Furthermore, geometry plays a crucial role in the construction of the loss function in a PINN. The loss function quantifies the discrepancy between the neural network predictions and the governing equations or physical constraints. Geometry specifies the points within the domain where the governing equations are enforced (known as interior points) and where the boundary conditions are imposed (boundary points). The inclusion of these points in the loss function allows the PINN to learn and enforce the physics at these specific locations, leading to an accurate representation of the system's behavior.

Lastly, the distribution of training data in a PINN is influenced by the geometry of the system. Training data is often distributed both within the interior of the domain and on its boundaries. Geometry determines the distribution of these data points, including their density, location, and the presence of any specific patterns or features. The distribution of training data affects the network's ability to learn and generalize the underlying physics accurately. By aligning the training data distribution with the geometric features of the system, PINNs can effectively capture the system's behavior and make accurate predictions.

In conclusion, geometry plays a significant and multifaceted role in PINNs. It defines the spatial domain, guides mesh generation, influences the construction of the loss function, and determines the distribution of training data. By incorporating the geometric features of the physical system, PINNs can accurately represent and capture the underlying physics. The consideration of geometry in PINNs enhances their ability to solve PDEs and other physics-based problems, making them valuable tools in scientific and engineering applications.

The PINN 100 further is associated with governing physics equations 104 which is further shaped by constraints 106.

In an example embodiment, Physics-informed neural networks (PINNs) 100 may be applied to a wide range of scientific and engineering problems that involve governing equations 104 described by differential equations or partial differential equations (PDEs). The specific physics equations used in PINNs depend on the nature of the problem being addressed. Below mentioned are some types of physics equations encountered in PINN applications:

Conservation Laws: Many physical systems may be described by conservation laws, which state that certain quantities are conserved over time or space. Examples include:

Continuity Equation: Describes the conservation of mass or fluid flow.

Conservation of Energy: Describes the transfer and conversion of energy in various forms.

Conservation of Momentum: Describes the change in momentum of a system.

Diffusion Equations: These equations describe the diffusion or spread of a quantity over time or space. Examples include:

Heat Equation: Describes the conduction of heat in a medium.

Fick's Law of Diffusion: Describes the diffusion of mass or particles.

Wave Equations: These equations describe the propagation of waves or oscillations. Examples include:

Wave Equation: Describes the propagation of waves, such as electromagnetic waves or acoustic waves.

Schrödinger Equation: Describes the quantum mechanical behavior of particles.

Elasticity Equations: These equations describe the behavior of elastic materials under deformation or stress. Examples include:

Hook's Law: Describes the linear relationship between stress and strain in a solid material.

Navier's Equations: Describes the equilibrium and motion of deformable solids.

Fluid Dynamics Equations: These equations describe the behavior of fluids, including incompressible and compressible flows. Examples include:

Navier-Stokes Equations: Describes the motion of viscous fluids and the conservation of momentum.

Euler Equations: Describes the behavior of inviscid fluids, neglecting viscosity effects.

Black-Scholes Equations: Describes the dynamics of a financial market.

These are just a few examples of the types of physics equations that may be used in PINNs. Depending on the problem domain, additional specialized equations may be employed, such as those from electromagnetism, quantum mechanics, or specific engineering disciplines. The choice of physics equations in a PINN depends on the physical phenomena being modeled and the goals of the problem at hand.

In an example embodiment, with regards to constraints 106 for partial differential equations (PDEs) using numerical methods, IC/BC refers to the initial and boundary conditions that are imposed to define a well-posed problem and ensure a unique solution.

IC stands for initial conditions, which specify the values of the dependent variables at the starting time or initial state of the system. These conditions are typically given as functions or fixed values at specific spatial locations. In an example embodiment, in a heat conduction problem, the initial temperature distribution in a domain may be prescribed.

BC stands for boundary conditions, which prescribe the behavior of the dependent variables at the boundaries of the problem domain. Boundary conditions may take various forms, depending on the specific physics being modeled. They are used to enforce constraints on the solution, often reflecting physical phenomena such as fluxes, temperatures, pressures, or symmetry. Boundary conditions may be given as either Dirichlet conditions (prescribing the value of the dependent variable) or Neumann conditions (prescribing the derivative of the dependent variable normal to the boundary).

The combination of initial and boundary conditions is crucial in defining a well-posed problem for solving PDEs. By specifying these conditions, the problem becomes fully determined, and a unique solution may be obtained.

When using numerical methods to solve PDEs, such as finite difference, finite element, or finite volume methods, the IC/BC are incorporated into the discretization scheme. The values or functions specified by the IC/BC are used to set up the initial state and to enforce the constraints at the boundaries of the computational domain. This allows the numerical algorithm to evolve the system over time or compute the steady-state solution while satisfying the given conditions.

In the context of physics-informed neural networks (PINNs), IC/BC play a vital role in training the network to approximate the solution of a PDE. The IC/BC are incorporated as constraints in the loss function during the training process. By enforcing the IC/BC, PINNs ensure that the learned solution satisfies the prescribed initial and boundary conditions, leading to physically consistent predictions.

Further, a transformer boosted neural network 108 may be employed as a part of a solution framework provided by the framework specific problem solver 110. The transformer boosted neural network 108

At the core of the transformer architecture is the self-attention mechanism, also known as scaled dot-product attention. Self-attention allows each element in a sequence to attend to all other elements, capturing the contextual relationships effectively. It calculates attention weights that indicate the importance of each element in the sequence concerning all other elements. These attention weights are then used to compute weighted sums, which form the contextual representation of each element.

The transformer architecture consists of several layers of self-attention and feed-forward neural networks. Each layer performs multi-head self-attention and applies position-wise fully connected feed-forward networks to process the input sequence. Skip connections and layer normalization are employed to facilitate the flow of information across different layers.

In an example embodiment, some generic neural networks may be but not limited to Feedforward Neural Network, Radial Basis Function (RBF) Neural Network, Convolutional Neural Network and Multilayer Perceptron.

Further, the framework-specific solver 110 feeds to a model 112 which helps in solving prediction 116.

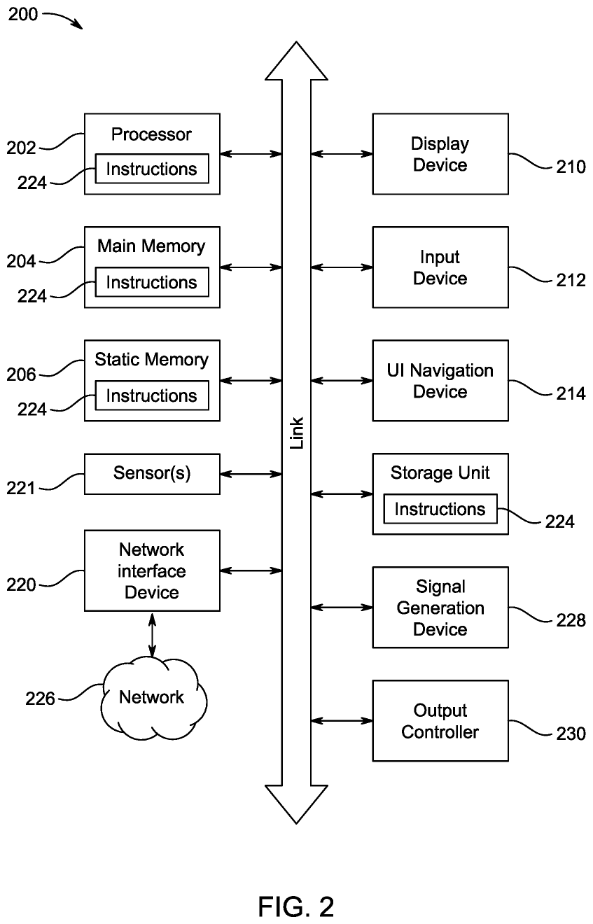

FIG. 2 illustrates a block diagram of an electronic circuitry for implementing a transformer boosted physics informed neural network, in accordance with an example embodiment.

The machine of FIG. 2 is shown as a standalone device, which is suitable for implementation of the concepts above. For the server aspects described above a plurality of such machines operating in a datacenter, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 200 includes at least one processor 202 (e.g., a central processing unit (CPU), a graphics processing unit (GPU), advanced processing unit (APU), or combinations thereof), one or more memories such as a main memory 204, a static memory 206, or other types of memory, which communicate with each other via link 208. Link 208 may be a bus or other type of connection channel. The machine 200 may include further optional aspects such as a graphics display unit 210 comprising any type of display. The machine 200 may also include other optional aspects such as an alphanumeric input device 212 (e.g., a keyboard, touch screen, and so forth), a user interface (UI) navigation device 214 (e.g., a mouse, trackball, touch device, and so forth), a storage unit 216 (e.g., disk drive or other storage device(s)), a signal generation device 218 (e.g., a speaker), sensor(s) 221 (e.g., global positioning sensor, accelerometer(s), microphone(s), camera(s), and so forth), output controller 228 (e.g., wired or wireless connection to connect and/or communicate with one or more other devices such as a universal serial bus (USB), near field communication (NFC), infrared (IR), serial/parallel bus, etc.), and a network interface device 220 (e.g., wired and/or wireless) to connect to and/or communicate over one or more networks 226.

Executable Instructions and Machine-Storage Medium

The various memories (i.e., 204, 206, and/or memory of the processor(s) 202) and/or storage unit 216 may store one or more sets of instructions and data structures (e.g., software) 224 embodying or utilized by any one or more of the methodologies or functions described herein. These instructions, when executed by processor(s) 202 cause various operations to implement the disclosed embodiments.

Example Machine Architecture and Machine-Readable Medium

FIG. 2 illustrates a representative machine architecture suitable for implementing the systems and so forth or for executing the methods disclosed herein. The machine of FIG. 2 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include storage devices such as solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically and unequivocally excludes carrier waves, modulated data signals, and other such transitory media, at least some of which are covered under the term “signal medium” discussed below.

Signal Medium

The term “signal medium” shall be taken to include any form of modulated data signal, carrier wave, and so forth. The term “modulated data signal” means a signal that has one or more of its characteristics set or changed in such a matter as to encode information in the signal.

Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

As used herein, the term “network” may refer to a long-term cellular network (such as GSM (Global System for Mobile Communication) network, LTE (Long-Term Evolution) network or a CDMA (Code Division Multiple Access) network) or a short-term network (such as Bluetooth network, Wi-Fi network, NFC (near-field communication) network, LoRaWAN, ZIGBEE or Wired networks (like LAN, et. all) etc.).

As used herein, the term “computing device” may refer to a mobile phone, a personal digital assistance (PDA), a tablet, a laptop, a computer, VR Headset, Smart Glasses, projector, or any such capable device.

As used herein, the term ‘electronic circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

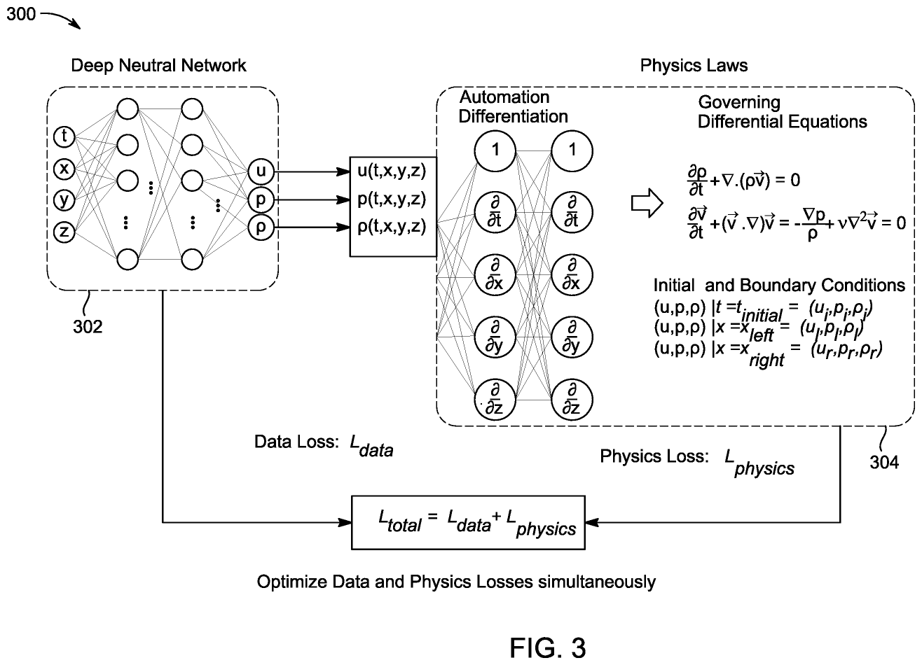

FIG. 3 illustrates a block diagram of an interface of a neural network with physics equation transformation, in accordance with an example embodiment. In an embodiment, the interface 300 may be but not limited to a Deep Neural Network (DNN) 302 with input parameters of three spatial dimension and time and output is velocity and density. Further, the data loss function is the Jacobian function.

In an example embodiment, the Deep Neural Network (DNN) 302 with inputs of x, y, z, and a time dimension, and outputs of density and velocity, where the loss function is the Jacobian, the network is designed to learn the Jacobian matrix that represents the derivatives of the outputs with respect to the inputs. Mentioned below is operation of a DNN.

Input Layer: The DNN starts with an input layer that takes in the four-dimensional input data: x, y, z coordinates, and the time dimension.

Hidden Layers: Following the input layer, the DNN consists of several hidden layers. The number of hidden layers and the number of units in each layer may vary based on the complexity of the problem and the available data.

Neuron Operations: Each neuron in the hidden layers performs a weighted sum of the inputs it receives and applies an activation function to the sum.

Dense Connections: In a fully connected DNN, each neuron in a hidden layer is connected to every neuron in the subsequent layer. These dense connections enable the network to learn complex relationships in the data.

Output Layer: The final layer of the DNN is the output layer, which produces the predictions for density and velocity. Each neuron in the output layer provides the predicted value for its corresponding target variable.

Training and Loss Function: The DNN is trained using a labeled dataset, where the input coordinates and time are associated with the known corresponding pressure, density, and velocity values. In this case, the loss function is defined as the discrepancy between the predicted Jacobian matrix and the true Jacobian matrix. The loss or Jacobian matrix represents the derivatives of the outputs (pressure, density, and velocity) with respect to the inputs (x, y, z, and time). The loss function is computed based on the difference between the predicted Jacobian and the true Jacobian.

Backpropagation and Optimization: The training process involves iteratively adjusting the weights and biases of the network to minimize the loss function. Backpropagation is used to compute the gradients of the loss function with respect to the network parameters. These gradients are then used to update the weights and biases through an optimization algorithm such as stochastic gradient descent (SGD) or Adam.

Prediction: Once the DNN is trained, it may be used to make predictions for density and velocity given new input coordinates and time values. The DNN takes in the input data, performs the forward pass through the layers, and produces the predicted outputs in the output layer.

By learning the Jacobian matrix, the DNN may capture the sensitivity of the outputs with respect to the inputs. This may be useful in various applications, such as sensitivity analysis, inverse problems, or control systems, where understanding the derivatives of the outputs is important. By training the network with the loss function based on the Jacobian, the DNN may approximate and generalize the derivatives of the outputs with respect to the inputs, enabling it to model and predict the behavior of the physical system with respect to changes in the inputs.

Further, the output of the DNN 302 is fed to the module 304 that applies the physics laws to constrain the output.

In an example embodiment, fluid dynamics equations are applied in a constraining role. Traditionally, solving fluid dynamics problems involves numerical methods such as finite difference, finite element, or finite volume methods. These methods discretize the flow domain and approximate the governing equations. However, these approaches may be computationally expensive and time-consuming, especially for complex and large-scale problems.

Physics-Informed Neural Networks (PINNs) offer an alternative approach by combining the power of deep learning with the physical principles embedded in fluid dynamics equations. PINNs are neural networks that are trained to approximate the solutions of the governing equations, enabling accurate and efficient predictions of fluid flow properties.

To apply fluid dynamics equations to a PINN, the first step is to formulate the problem by defining the flow domain, boundary conditions, and any additional physical properties or constraints. The equations that describe fluid flow, such as the Navier-Stokes equations for incompressible flows, are then identified.

The neural network architecture is designed to handle the fluid dynamics problem at hand. The architecture typically consists of input layers, hidden layers, and output layers. The number of neurons and layers may be adjusted based on the complexity of the problem. The input to the network usually includes spatial coordinates (x, y, z) and time as well.

Generating training data for the PINN involves a combination of labeled data and physics-informed data. Labeled data includes known solutions of the fluid dynamics problem at specific points within the flow domain. Physics-informed data includes randomly or strategically selected points where the network enforces the fluid dynamics equations. These data points help in capturing the underlying physics of the problem and guide the network towards accurate predictions.

The loss function used in training the PINN is defined to incorporate both data-driven and physics-driven terms. The data-driven term quantifies the discrepancy between the predicted outputs of the network and the labeled data. The physics-driven term ensures that the network satisfies the fluid dynamics equations. It is typically formulated as the residual of the governing equations, representing the difference between the predicted and true derivatives or gradients.

Enforcing the fluid dynamics equations is achieved through the physics-informed loss term. This term evaluates the residuals of the equations at selected points within the flow domain. The network adjusts its weights and biases to minimize this loss term during the training process, which effectively guides the network to adhere to the physics embedded in the fluid dynamics equations.

The PINN is trained using optimization algorithms such as stochastic gradient descent (SGD) or Adam. The training process iteratively adjusts the network parameters to minimize the combined loss function. This fine-tunes the network to improve its predictions and adherence to the fluid dynamics equations.

Once the PINN is trained, it may be employed for prediction and inference tasks. Given new input conditions or flow scenarios, the PINN may estimate various fluid flow properties such as velocity, pressure, or vorticity throughout the flow domain. The network may quickly provide predictions with high accuracy, making it a valuable tool for exploring and understanding fluid flow phenomena.

By incorporating fluid dynamics equations into the PINN's training process, the network learns to approximate the solutions of the governing equations and capture the complex behavior of fluid flows. PINNs offer significant advantages over traditional numerical methods by providing faster and more efficient solutions to fluid dynamics problems. Their ability to learn and generalize from data allows for the analysis of complex flow phenomena, aiding in the design and optimization of various engineering systems involving fluid flows. PINNs bridge the gap between deep learning and physics, offering a promising avenue for advancing our understanding of fluid dynamics.

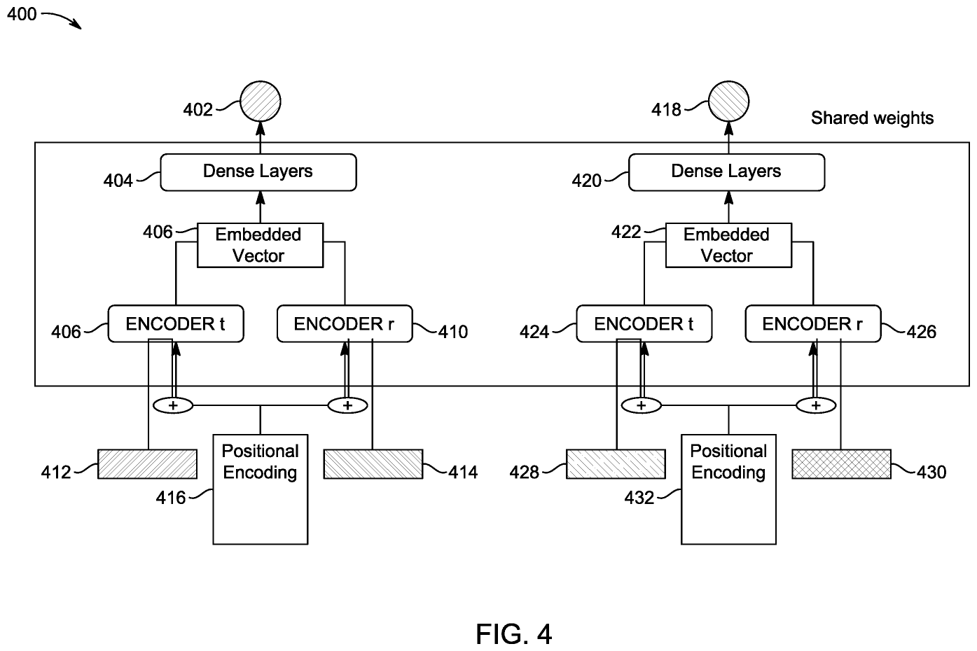

FIG. 4 a block diagram the design of the transformer, in accordance with an example embodiment.

In an embodiment, in the context of Physics-Informed Neural Networks (PINNs), the specific components mentioned in FIG. 4, including encoder r 410, encoder t 408, positional encoding, embedded vector, dense layers, and shared weights, may be utilized to incorporate the physical principles of a problem into the neural network architecture. Below mentioned are how these elements are employed in PINNs:

Encoder r 410 and Encoder t 408: In PINNs, the input to the neural network often includes spatial coordinates (x, y, z) and time (t) dimensions. Encoder r 410 and Encoder t 408 refer to separate branches or subnetworks that handle the spatial and temporal inputs, respectively. Encoder r 410 processes the spatial coordinates (x, y, z), while Encoder t 408 processes the time dimension. These encoders capture the essential features from the input data and transform them into meaningful representations.

Positional Encoding 416: Positional encoding is used to embed the positional information into the input data of a PINN. In the context of PINNs, positional encoding may be applied to the spatial coordinates (x, y, z) and time (t). It allows the network to differentiate between different positions or time steps within the input data, enabling it to capture the evolution of the physical system over time or space.

Embedded Vector 406: In PINNs, embedded vectors may be used to represent other relevant input features apart from the spatial coordinates and time. In an example embodiment, if there are categorical variables or physical parameters associated with the problem, embedded vectors may be employed to capture their semantic relationships and represent them in a continuous vector space. These embedded vectors help the network to learn meaningful representations of the additional input data, contributing to the overall predictive capabilities of the PINN.

Dense Layers 404: Dense layers, also known as fully connected layers, play a vital role in PINNs. They are responsible for learning complex relationships between the encoded inputs and the desired output variables of the problem, such as density or velocity. Dense layers enable the network to capture the underlying physics and nonlinear behavior of the system. The number of dense layers, along with the number of neurons in each layer, may be adjusted based on the complexity of the problem and the network's capacity requirements.

Shared Weights: In PINNs, shared weights refer to the practice of using the same set of weights across multiple locations or time steps in the network. This technique helps enforce the physical constraints and symmetries present in the problem. For instance, if the governing equations of the system exhibit translational symmetry, sharing weights across different spatial locations ensures that the network adheres to this symmetry constraint. Shared weights enable the network to generalize its learned knowledge and improve computational efficiency by reducing the number of trainable parameters.

By combining these components, a PINN may learn the underlying physics of a system while making predictions or estimating the desired variables, such as density or velocity. The encoders, positional encoding, embedded vectors, dense layers, and shared weights collectively contribute to capturing the physical principles, handling the input data, and modeling the complex relationships required in a physics-informed approach. This allows the PINN to provide accurate predictions and gain insights into the behavior of the physical system being studied.

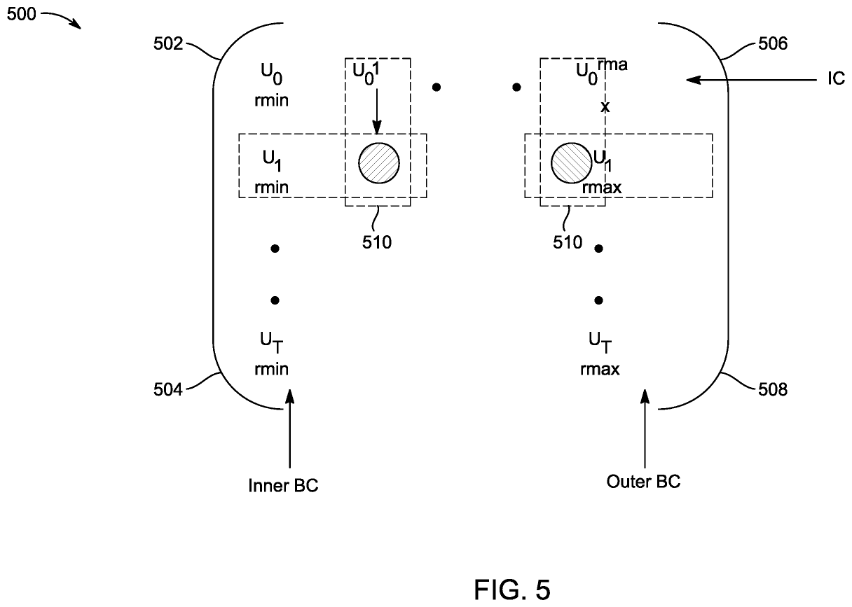

FIG. 5 shows a boundary conditions computation matrix, in accordance with an example embodiment. In an embodiment a boundary conditions computation matrix 500 may initially be sparsely populated with boundary conditions U0 rmin 502, UT rmin 504, U0 rmax 506 and U0 rmax 508.

In an embodiment, a first value 510 is computed using the boundary conditions and a second value 512 which is further apart in space and time is computed.

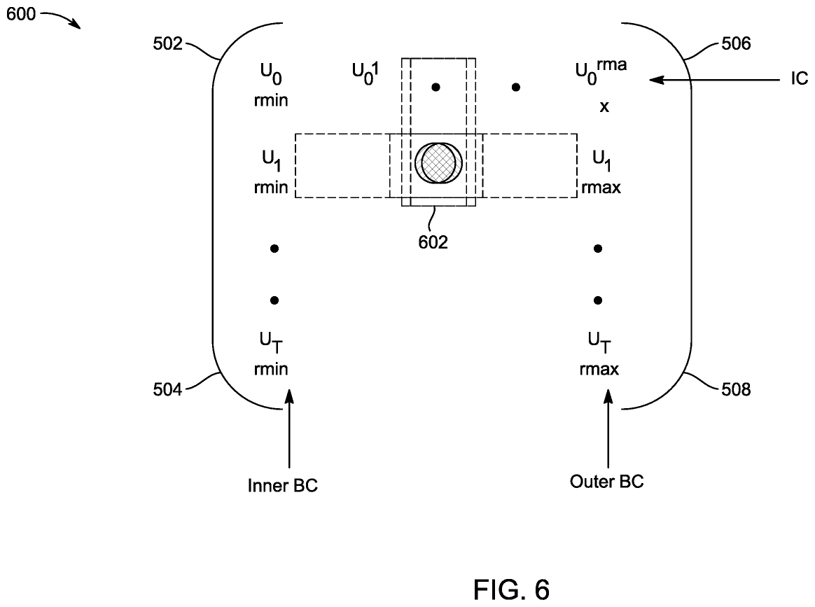

FIG. 6 illustrates a boundary conditions computation matrix with joining condition, in accordance with an example embodiment. In an embodiment, after the computation of the first value 510 and second value 512 using boundary conditions for example U0 rmin 502, UT rmin 504, U0 rmax 506 and U0 rmax 508. The computation is repeated to compute multiple values and fill up the sparse matrix. When the computation targets the same slot in the sparse matrix the values are joined or pooled.

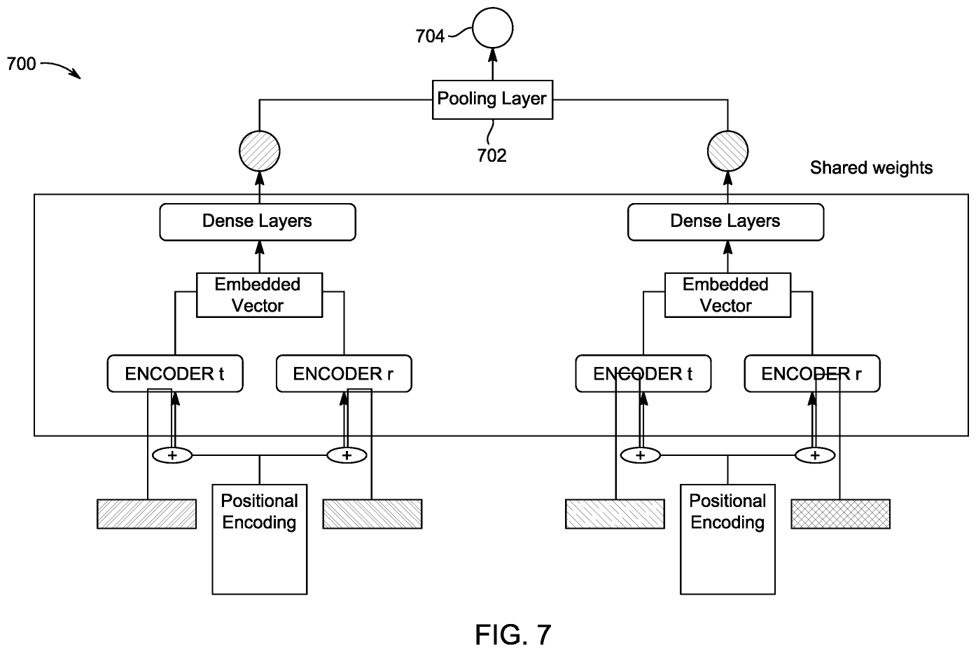

FIG. 7 shows a block diagram of the design of the transformer with pooling layer, in accordance with an example embodiment. In an example embodiment, boundary conditions are crucial in PINNs for predicting values. In fluid dynamics, for example, boundary conditions provide information about the flow properties at the boundaries of the domain. These conditions may be incorporated as additional constraints during the training process. By enforcing the boundary conditions in the loss function, the network learns to produce predictions that satisfy the prescribed conditions at the boundaries, enhancing the accuracy of the predictions.

In another embodiment, pooling values may be achieved using separate computations in PINNs by using a pooling layer 702. To achieve pooled value 704, pooling operations, such as max pooling, average pooling, or a weighted pooling may be applied to specific layers or branches of the network to down sample the data and capture essential features. For instance, in a PINN architecture with separate encoders for spatial and temporal inputs, pooling may be applied independently to each encoder to summarize the extracted information. This allows the network to capture the most salient features while reducing the computational complexity of subsequent layers.

By combining these components and techniques, PINNs may effectively capture the physical principles, handle input data, predict values satisfying boundary conditions, and pool relevant information. This enables PINNs to learn the underlying physics of the system and make accurate predictions in various domains, such as fluid dynamics, solid mechanics, or electromagnetics.

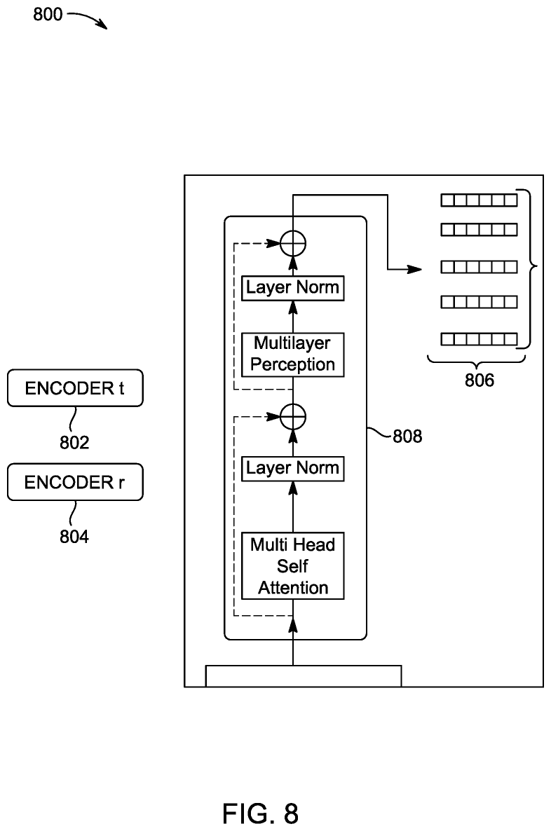

FIG. 8 a block diagram of an encoders' function, in accordance with an example embodiment. In an embodiment, a Transformer encoder 800, without a decoder, is a crucial component of the Transformer architecture. The Transformer encoder is responsible for capturing contextual representations of input sequences. Further, the encoder may separately process time and space input using an encoder t 802 and an encoder r 804. Mentioned below is the architecture of a Transformer encoder.

Input Embeddings: The input to the Transformer encoder is a sequence of tokens. Each token is first transformed into a continuous vector representation known as an input embedding. These embeddings capture the semantic meaning of the tokens and provide a numerical representation that the Transformer may process.

Positional Encoding: Since Transformers do not inherently understand the order of tokens in a sequence, positional encoding is added to incorporate the sequence position information. Positional encoding assigns unique values or patterns to different positions within the input sequence, allowing the model to differentiate between positions and consider the ordering of the tokens.

Self-Attention Mechanism: The core component of the Transformer encoder is the self-attention mechanism, also known as scaled dot-product attention. Self-attention allows the model to attend to different positions within the input sequence and capture dependencies between tokens. It computes attention weights that determine the importance of each token with respect to others, enabling the model to focus on relevant information.

Multi-Head Attention: To enhance the expressive power and capture different types of dependencies, the self-attention mechanism is typically implemented with multiple attention heads. Each attention head performs attention computation independently, allowing the model to attend to different parts of the input sequence simultaneously. The outputs of the multiple attention heads are concatenated and linearly transformed to generate the final self-attention output.

Feed-Forward Neural Networks: After the self-attention layer, the Transformer encoder includes position-wise feed-forward neural networks or multi-layer perceptron. These networks consist of fully connected layers with a non-linear activation function in between. The feed-forward networks provide a mechanism for the model to learn complex mappings and capture non-linear relationships between tokens in the sequence.

Residual Connections and Layer Normalization: To aid in the flow of information and improve training stability, residual connections are added in the Transformer encoder. These connections allow the network to retain information from earlier layers and propagate it forward. Layer normalization is applied after each sub-layer, normalizing the activations, and improving the stability and convergence of the model.

The Transformer encoder architecture repeats the self-attention and feed-forward layers multiple times, forming a stack of identical layers. Each layer receives the output from the previous layer as input, allowing the model to capture increasingly complex patterns and representations. The number of layers in the encoder may vary based on the complexity of the task and the size of the input sequences.

M tasks like machine translation, where both encoding and decoding are required, the Transformer architecture consists of both an encoder and a decoder. However, in applications where only encoding is necessary, such as physics informed neural networks, the Transformer encoder may be used independently to capture contextual representations of input sequences.

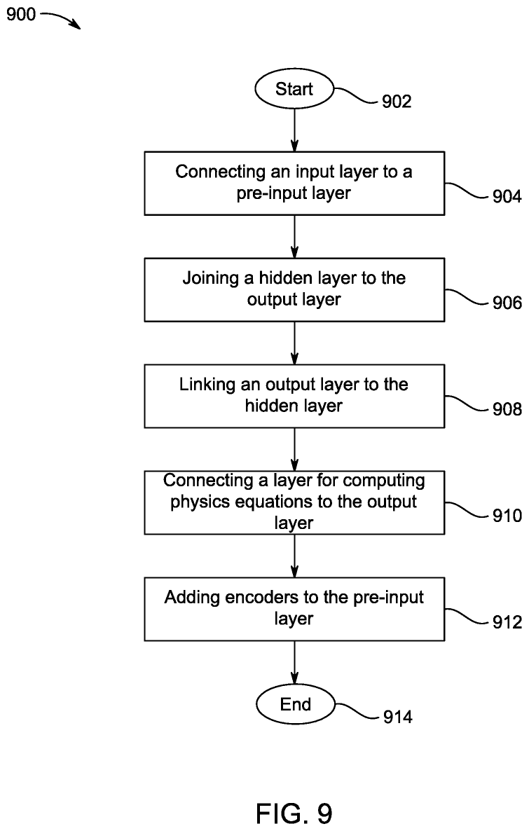

FIG. 9 illustrates a flow diagram of a method for augmenting a neural network, in accordance with an example embodiment. It will be understood that each block of the flow diagram of the method 900 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the evaluation system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 900 illustrated by the flow diagram of FIG. 900 for augmenting a neural network starts at step 902.

The method at step 904, may include connecting an input layer to a pre-input layer.

In an embodiment, connecting a Transformer layer to an input layer involves integrating the Transformer architecture into the network's overall design to leverage its powerful sequence modeling capabilities. Transformer layer may be connected to an input layer in the context of PINNs as follows

In PINNs, the input layer represents the physical parameters, spatial coordinates, and time dimension that define the problem being studied. The input layer encodes the initial conditions and relevant inputs required to solve the physics equations.

The Transformer encoder layer is introduced after the input layer to capture the contextual representations of the input data. It leverages the self-attention mechanism and other components of the Transformer architecture to model the dependencies and interactions between different inputs.

Before feeding the inputs into the Transformer encoder, they need to be transformed into appropriate representations. This involves generating embeddings for the inputs to capture their semantic meaning and applying positional encoding to incorporate the order or position information of the inputs.

The Transformer encoder layer consists of multiple self-attention heads and position-wise feed-forward neural networks. The self-attention mechanism enables the network to attend to relevant inputs, considering their relationships and importance. The feed-forward networks capture non-linear dependencies and learn complex mappings between the inputs.

After passing through the Transformer encoder layer, the contextual representations obtained from the self-attention mechanism may be concatenated with or added to the original input layer. This integration allows the network to leverage the learned contextual information while retaining the original physics-related inputs. The exact method of integration (concatenation, addition, etc.) may depend on the specific problem and network architecture.

Following the integration of the Transformer layer, additional dense layers or other types of layers may be added to the network. These layers help in capturing further complex relationships, combining the encoded inputs from the Transformer layer with additional features or intermediate representations. Finally, the output layer of the network produces the desired predictions or estimates, such as density or velocity, based on the integrated information.

By connecting a Transformer layer to the input layer in a PINN, the network gains the ability to capture complex dependencies and contextual information from the input data. The self-attention mechanism of the Transformer allows the network to model interactions between different inputs, including spatial coordinates, physical parameters, and time, improving the network's ability to learn and predict the physics-informed quantities of interest.

The method 900, at step 906, may include joining a hidden layer to the input layer.

In an example embodiment, the input layer and hidden layers are fundamental components of a neural network, working together to process and transform input data into meaningful representations that lead to accurate predictions or classifications. The interface between these layers plays a crucial role in the overall functioning of the network.

The input layer is the initial layer of the neural network, responsible for receiving the input data. It consists of neurons, with each neuron representing a feature or attribute of the input. For example, in an image classification task, each neuron in the input layer might correspond to a pixel value. The number of neurons in the input layer is determined by the dimensionality of the input data.

Each neuron in the input layer applies an activation function to its respective input. This activation function introduces non-linearity into the network, enabling the neurons to model complex relationships between the inputs. Common activation functions include the sigmoid, hyperbolic tangent, and rectified linear unit (ReLU). The activation function transforms the input into a more expressive representation, facilitating the flow of information through the network.

The input layer is connected to the hidden layers through weighted connections. These connections represent the synaptic weights or parameters of the network. The weights determine the strength of the connection between neurons and are adjusted during the training process to optimize the network's performance. Each neuron in the hidden layers receives inputs from the neurons in the previous layer, which are multiplied by the corresponding weights and summed to produce the inputs for the current hidden layer. This process allows information to flow from the input layer to the hidden layers.

The hidden layers, as the name suggests, are not directly observable or part of the network's output. They act as intermediate layers between the input and output layers. The hidden layers perform computations on the input data, progressively transforming and abstracting the information to extract meaningful representations. They capture complex patterns and relationships in the data, enabling the network to learn and generalize from the input information.

Neurons in the hidden layers also apply activation functions to their inputs, introducing non-linearity and allowing the network to model complex relationships. The choice of activation function depends on the specific task and the desired properties of the network. Rectified linear units (ReLU) are commonly used due to their simplicity and effectiveness in capturing non-linear patterns and hyperbolic tangents (tanh) are commonly used in PINNs due to the function being infinitely differentiable. Differentiability is an important requirement for the automatic differentiation part of PINNs.

The interface between the input layer and hidden layers involves the passing of data through the weighted connections, applying activation functions, and propagating activations forward through the network. This process allows the network to progressively learn and transform the input data, extracting meaningful features and representations. The depth and width of the hidden layers, i.e., the number of layers and neurons, may be adjusted based on the complexity of the problem and the network's capacity to learn.

The interface between the input layer and hidden layers is a critical component of neural networks, as it determines how information is processed and transformed throughout the network. Through this interface, the network may learn and discover complex patterns in the input data, leading to improved performance and accurate predictions. By leveraging the strengths of the input layer and hidden layers, neural networks may tackle a wide range of tasks, from image recognition to natural language processing, and achieve remarkable results.

The method 900, at step 908, may include linking an output layer to the hidden layer.

In an example embodiment, the interface between the output layer and hidden layers in a neural network is a crucial component that determines how the network's computed representations are transformed into meaningful output predictions or classifications. This interface plays a vital role in the overall functioning of the network and in generating accurate results.

The hidden layers of a neural network are responsible for capturing and representing the complex patterns and relationships within the input data. These layers progressively transform and abstract the information, extracting meaningful representations that capture the underlying structure of the data. The hidden layers leverage weighted connections and activation functions to propagate and process the information.

The interface between the hidden layers and the output layer involves the transformation of the hidden layer representations into final output predictions. The output layer is the last layer of the neural network and typically consists of neurons that correspond to the desired output classes or regression values. The number of neurons in the output layer depends on the specific task at hand.

Each neuron in the output layer receives inputs from the neurons in the preceding hidden layers. These inputs are weighted by the connections between the hidden layers and the output layer. The weights associated with these connections represent the learned parameters of the network, which have been optimized during the training process to produce accurate predictions.

The output layer neurons then apply an activation function appropriate for the task at hand. For classification tasks, common activation functions include the SoftMax function, which produces a probability distribution over the output classes. For regression tasks, linear activation functions or others such as sigmoid or hyperbolic tangent may be used depending on the desired output range.

The interface between the hidden layers and the output layer is responsible for mapping the learned representations of the hidden layers to meaningful output predictions. Through the weighted connections and activation functions, the network combines and processes the information from the hidden layers to produce the final outputs.

During the training phase, the network adjusts the weights and biases associated with the connections in order to minimize the discrepancy between the predicted outputs and the ground truth values. This process, known as backpropagation, propagates the error from the output layer back to the hidden layers, allowing the network to update its parameters and improve its performance.

The interface between the output layer and hidden layers plays a critical role in the overall success of a neural network. It determines how the network's learned representations are transformed into actionable predictions or classifications. By leveraging the information captured in the hidden layers, the network may generate accurate outputs that are relevant to the specific task at hand.

The method 900, at step 910, may include connecting a layer for computing physics equations to the output layer.

In an example embodiment, the interface between the output layer and the physics equation computation layer in a Physics-Informed Neural Network (PINN) is a critical component that bridges the gap between the learned representations of the neural network and the underlying physics equations. This interface allows the network to incorporate domain-specific knowledge and enforce physical constraints in its predictions, making it suitable for solving physics-based problems.

The output layer of the neural network is responsible for producing the desired predictions or estimates based on the learned representations. In the context of a PINN, these predictions typically include quantities such as velocity, density, pressure, or any other physical variable of interest. The number of neurons in the output layer depends on the specific problem and the number of variables being predicted.

The physics equation computation layer is the interface that connects the output layer to the physics equations governing the system being studied. This layer is designed to ensure that the predictions made by the network adhere to the underlying laws of physics. It facilitates the incorporation of physical constraints and knowledge into the network's predictions.

The physics equation computation layer is responsible for evaluating the physics equations using the predictions made by the network. It represents the fundamental principles and governing equations specific to the problem domain. These equations capture the relationships and interactions between the physical variables involved in the problem. Examples of such equations include the Navier-Stokes equations for fluid dynamics or the Schrödinger equation for quantum mechanics.

The interface between the output layer and the physics equation computation layer involves passing the predicted values from the output layer to the physics equations. These predictions serve as input to the equations, allowing them to be evaluated and compared against the actual physics constraints.

In a PINN, the physics equations are typically formulated as loss functions. The difference between the predicted values from the output layer and the values computed from the physics equations is quantified using these loss functions. This discrepancy is used to guide the training process and optimize the network parameters, ensuring that the network's predictions satisfy the physical laws.

The interface between the output layer and the physics equation computation layer is established through backpropagation. The gradients of the loss functions with respect to the network parameters are computed and used to update the weights and biases of the network, iteratively improving its predictions while satisfying the physics equations.

This interface allows the network to learn and incorporate the physical principles and constraints into its predictions. By minimizing the discrepancy between the predicted values and the values computed from the physics equations, the network is able to provide solutions that are consistent with the underlying physics.

The interface between the output layer and the physics equation computation layer in a PINN enables the network to combine the power of data-driven learning with the constraints and knowledge encoded in the physics equations. This integration ensures that the network produces predictions that are not only accurate but also physically meaningful. PINNs have been successfully applied to a wide range of problems in various fields of physics, including fluid dynamics, solid mechanics, electromagnetics, and more, offering a promising approach for tackling complex physics-based tasks.

The method 900, at step 912, may include adding encoders to the pre-input layer.

In an example embodiment, in the context of physics-informed neural networks (PINNs), encoders may be utilized to process the input variables or spatial dimensions. For example, in fluid dynamics simulations, encoders may be employed to process the spatial coordinates (x, y, z) or time dimension before feeding the information into the transformer layers. This allows the model to capture local patterns in the physical domain, such as boundary conditions or spatial variations, while leveraging the transformer's ability to capture global dependencies.

By combining encoders with transformers, the model benefits from a more holistic understanding of the data. The encoders contribute by capturing local patterns and details, while the transformers excel at capturing global dependencies and long-range interactions. This synergy leads to improved performance and more robust representations, enabling the model to make accurate predictions or classifications.

In some example embodiments, a computer programmable product may be provided. The computer programmable product may comprise at least one non-transitory computer-readable storage medium having stored thereon computer-executable program code instructions that when executed by a computer, cause the computer to execute the method 900.

In an example embodiment, an apparatus for performing the method 900 of FIG. 9 above may comprise a processor (e.g., the processor 202) configured to perform some or each of the operations of the method 900. The processor may, for example, be configured to perform the operations (902-912) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (902-912) may comprise, for example, the processor 202 which may be implemented in the system 200 and/or a device or circuit for executing instructions or executing an algorithm for processing information as described above.

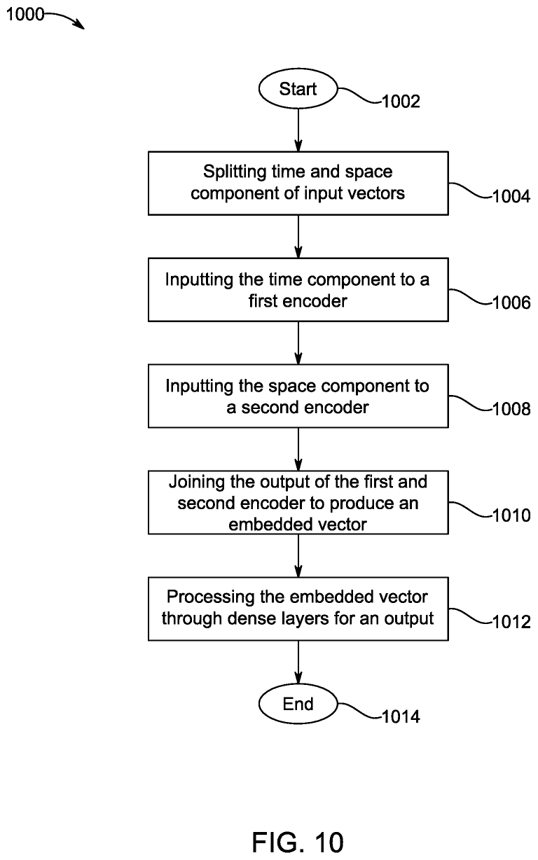

FIG. 10 illustrates a method 1000 for method for operation of a transformer booster, in accordance with an example embodiment. It will be understood that each block of the flow diagram of the method 1000 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the evaluation system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 1000 illustrated by the flow diagram of FIG. 10 for operation of a transformer booster may starts at step 1002.

The method 1000, at step 1004, may include splitting time and space component of input vectors. In an embodiment, in a Physics-Informed Neural Network (PINN) with a transformer architecture, input vectors with time and space components are handled in a way that allows the network to effectively capture the dynamics and spatial variations of the physical system under consideration. The transformer model, originally designed for natural language processing, has been adapted to handle input vectors with both time and space dimensions, enabling the network to learn and represent the underlying physics in a comprehensive manner.

In many physics problems, the inclusion of both time and space components is crucial for accurately modeling and predicting the behavior of the system. The time component captures the temporal evolution of the system, while the space component represents the spatial distribution of the physical variables. By incorporating both aspects into the input vectors, the transformer model in a PINN may capture the dynamic and spatial dependencies necessary for solving physics-based problems.

To handle input vectors with time and space components, the transformer model utilizes a combination of positional encoding and embedding techniques. Positional encoding is employed to convey the sequential and spatial information, allowing the network to understand the order and arrangement of the input vectors.

Further, in a Physics-Informed Neural Network (PINN) with a transformer architecture, the splitting of time and space components of an input is a crucial step that enables the network to effectively model and capture the dynamics and spatial variations of the physical system under consideration. By separating the time and space components, the transformer model may process them individually and learn the dependencies specific to each aspect, enhancing the network's ability to solve physics-based problems.

To split the time and space components of an input in a PINN transformer, the input vectors are typically structured in a way that separates the temporal and spatial information. This allows for the independent handling of time and space components, as they often have different characteristics and relationships within the physics problem being solved.

The method 1000, at step 1006, may include Inputting the time component to a first encoder.

In an example embodiment, the time component plays a crucial role in capturing the temporal dynamics of the physical system being studied. The time component is processed by an encoder in a PINN to enable the network to understand the temporal evolution of the variables and learn the dependencies and patterns that exist over time.

The encoder in a PINN is responsible for transforming the input data into a format that may be effectively processed by the subsequent layers of the network. When it comes to the time component, there are several approaches that may be employed to process and incorporate it into the network architecture.

One common technique used to process the time component is positional encoding.

Positional encoding is a method that introduces information about the order or position of the input data into the network. In the context of the time component, positional encoding allows the encoder to capture the temporal order and relationships between different time steps.

In positional encoding, specific encoding vectors are added to the input data, representing the position or order of each time step. These encoding vectors may be learned during the training process or predefined based on the problem at hand. By incorporating positional encoding, the encoder becomes aware of the temporal sequence of the input data, allowing the network to capture the temporal dynamics of the system.

The encoding vectors convey information about the relative positions of the time steps. They can represent different aspects such as the time interval between consecutive steps or the absolute time values. The specific encoding scheme used depends on the problem and the desired representation of time.

Another approach to process the time component in a PINN encoder is through embedding techniques. Embedding involves mapping the discrete time values to continuous vector spaces with lower dimensions. This mapping allows the network to learn meaningful representations and relationships between different time steps.

In the case of time embedding, each time step is associated with a continuous vector in a lower-dimensional space. This embedding captures the essential characteristics of the time component, enabling the network to learn patterns and dependencies in the temporal domain. The embedding vectors can be learned during the training process or predefined based on prior knowledge.

Once the time component has been processed by the encoder using positional encoding or embedding techniques, the resulting representations are then fed into the subsequent layers of the PINN for further processing and learning. These representations contain valuable information about the temporal dynamics of the system, allowing the network to capture patterns, dependencies, and temporal relationships in the data.

The subsequent layers of the PINN, such as transformer layers or dense layers, operate on the encoded time representations along with other input components. These layers leverage the encoded time information to learn the dependencies between the time component and other variables of interest, and ultimately make predictions or solve the physics-based problem.

The method 1000, at step 1008, Inputting the space component to a second encoder.

In an example embodiment, the space component is a critical aspect that captures the spatial distribution and interactions of physical variables within the system. The space component is processed by an encoder in a PINN to effectively model and learn the spatial dependencies and patterns in the data.

The encoder in a PINN is responsible for transforming the input data, including the space component, into a format that may be effectively processed by the subsequent layers of the network. When it comes to the space component, various techniques may be employed to process and incorporate spatial information into the network architecture.

One common approach to processing the space component is through the use of positional encoding. Positional encoding allows the encoder to capture the spatial order and relationships between different spatial positions or coordinates within the system. It introduces information about the spatial arrangement of the input data to enable the network to understand the spatial variations and interactions.

In positional encoding, specific encoding vectors are added to the input data, representing the position or order of each spatial position or coordinate. These encoding vectors may be learned during the training process or predefined based on prior knowledge. By incorporating positional encoding, the encoder becomes aware of the spatial distribution and relationships, allowing the network to capture the spatial patterns and dependencies within the physical system.

The encoding vectors convey information about the relative positions of the spatial coordinates. They may represent aspects such as the distance between different spatial positions or the orientation of specific regions within the system. The specific encoding scheme used depends on the problem and the desired representation of space.

Another approach to processing the space component in a PINN encoder is through embedding techniques. Similar to time embedding, space embedding involves mapping the discrete spatial coordinates or dimensions to continuous vector spaces with lower dimensions. This embedding captures the essential characteristics of the spatial information, enabling the network to learn meaningful representations and relationships.

In space embedding, each spatial coordinate or dimension is associated with a continuous vector in a lower-dimensional space. This embedding allows the network to capture the spatial variations and interactions within the system, enabling the learning of spatial patterns and dependencies. The embedding vectors may be learned during the training process or predefined based on prior knowledge.

Once the space component has been processed by the encoder using positional encoding or embedding techniques, the resulting representations are then fed into the subsequent layers of the PINN for further processing and learning. These representations contain valuable information about the spatial distribution and interactions of the physical variables, allowing the network to capture spatial patterns, dependencies, and relationships.

The subsequent layers of the PINN, such as transformer layers or dense layers, operate on the encoded space representations along with other input components. These layers leverage the encoded space information to learn the dependencies between the space component and other variables of interest, and ultimately make predictions or solve the physics-based problem.

The method 1000, at step 1010, joining the output of the first and second encoder to produce an embedded vector.

In an example embodiment, combining the encoded time and space components to produce an embedded vector holds significant importance in capturing the intricate interplay between temporal dynamics and spatial variations within the physical system. This integration allows the network to holistically understand the dependencies and patterns that emerge from the interaction of time and space, resulting in improved accuracy and robustness in solving physics-based problems.

The encoded time and space components are representations obtained through specialized encoding techniques, such as positional encoding or embedding, that process and capture the inherent characteristics of each component separately. The encoded time component encapsulates the temporal order, dependencies, and evolution of the system over time, while the encoded space component captures the spatial distribution, interactions, and variations of the physical variables within the system.

By combining these encoded components into an embedded vector, the PNN creates a unified representation that incorporates both temporal and spatial information. This embedded vector forms a holistic representation of the input data, allowing the network to capture the complex interactions between time and space and effectively model the physics of the system.

The significance of combining the encoded time and space components lies in the fact that many physical phenomena exhibit intricate relationships between temporal dynamics and spatial variations. In physics, the behavior of variables often depends not only on their values at a given point in time but also on their distribution across different spatial locations. For example, fluid flow patterns are influenced by both the temporal changes in velocity and the spatial variations in pressure or temperature.

By integrating the encoded time and space components, the PNN may capture the intricate coupling between time and space, enabling the network to learn and exploit the dependencies and patterns that arise from their interaction. This holistic representation enhances the model's ability to generalize and make accurate predictions by considering the comprehensive influence of both temporal and spatial factors on the physical system.

Furthermore, the embedded vector provides a compact representation of the input data that may be effectively processed by subsequent layers of the PINN. This integration allows the network to leverage the strengths of various layers, such as transformer layers or dense layers, to capture the complex relationships between the embedded vector and other variables of interest.

The embedded vector also facilitates information propagation and sharing across different parts of the network. By combining the time and space components, the PINN enables the model to attend to specific temporal and spatial features simultaneously, enhancing its capability to capture the underlying physics accurately.

The method 1000, at step 1012 may include processing the embedded vector through dense layers for an output.

In an embodiment, the output from multiple sources is further pooled by a pooling layer for enhancing accuracy.

In some example embodiments, a computer programmable product may be provided. The computer programmable product may comprise at least one non-transitory computer-readable storage medium having stored thereon computer-executable program code instructions that when executed by a computer, cause the computer to execute the method 1000.

In an example embodiment, an apparatus for performing the method 1000 of FIG. 10 above may comprise a processor (e.g., the processor 202) configured to perform some or each of the operations of the method 1000. The processor may, for example, be configured to perform the operations (1002-1012) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (1002-1012) may comprise, for example, the processor 202 which may be implemented in the system 200 and/or a device or circuit for executing instructions or executing an algorithm for processing information as described above.

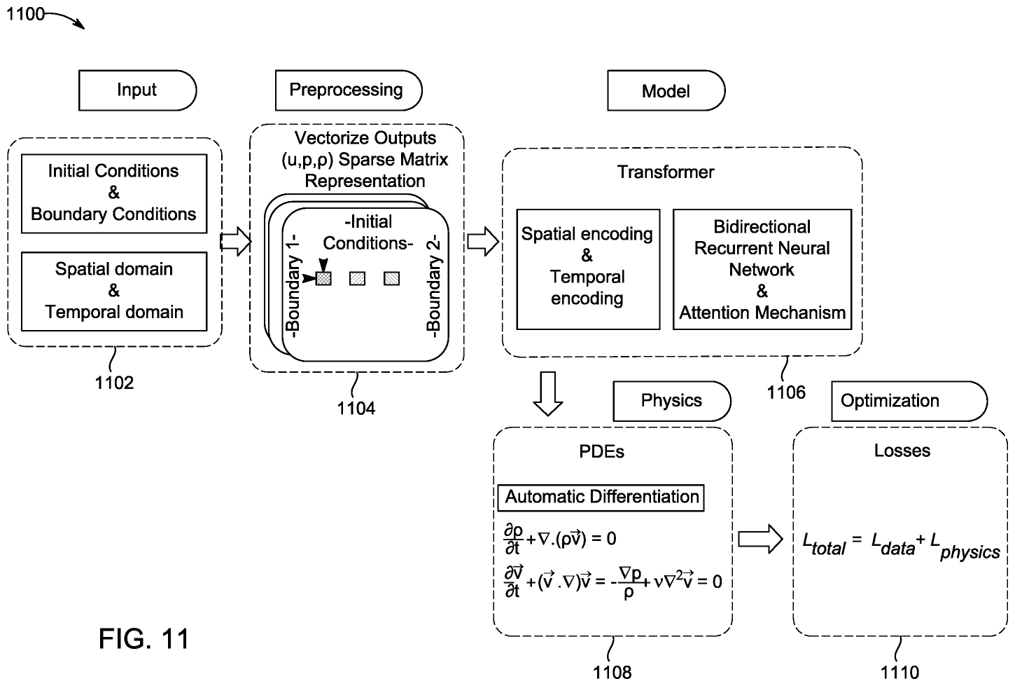

FIG. 11 illustrates a block diagram of a workflow of a transformer boosted PINNs, in accordance with an example embodiment. The block 1102 comprises the initial conditions and boundary conditions and also the inputs which comprise in spatial and temporal domain. In the next block 1104 the inputs are vectorized into a sparse matrix representation bounded by the initial conditions and the boundary conditions. Also at 1106, the transformer which comprises of spatial and temporal encoders takes in the vectorized inputs and forwards it to the bidirectional recurrent neural network and attention mechanism.

Further, the output of the bidirectional recurrent neural network and attention mechanism is fed to the physics layer 1108 which applies the physics equations in some embodiments a partial differential equation. Finally, the output of the physics layer is computed by summing up the loss function on the data and the physics at the optimization block 1110.

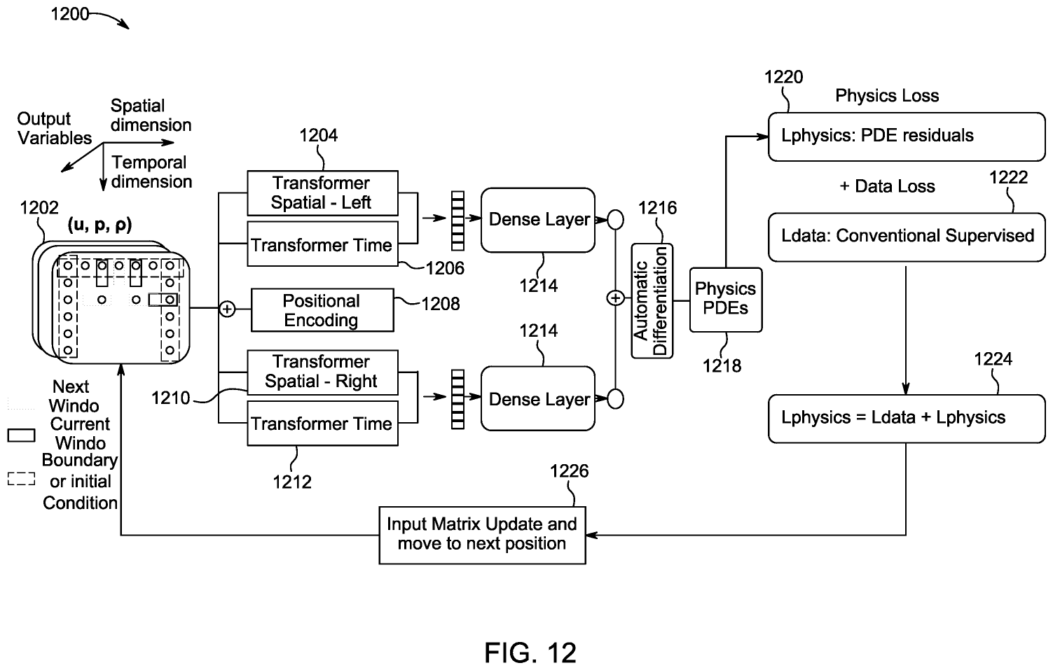

FIG. 12 illustrates a block diagram of an autoregressive loop of a transformer boosted PINNs, in accordance with an example embodiment. The block 1202 comprises the inputs that are vectorized into a sparse matrix bounded by the initial conditions and the boundary conditions. The sparse matrix is further split into left inputs and right inputs of the matrix with positional encoding 1208. The left inputs are further divided into time component which is fed into transformer time left 1206 and spatial components fed to transformer spatial left 1204. Similarly, the right inputs are further divided into time component which is fed into transformer time right 1210 and spatial components fed to transformer spatial right 1212.

Further, the output of the transformers are fed to dense layers 1214. Additionally, the output of the dense layers 1214 are summed up and an automatic differentiation 1216 is applied and further fed to a physics PDE 1218. At this point the loss function of PDE 1220 and the loss function of data 1222 is computed and summed up to obtain the total loss 1224. The total loss 1224 is used to update input matrix 1226 and iteratively proceed to the next element.

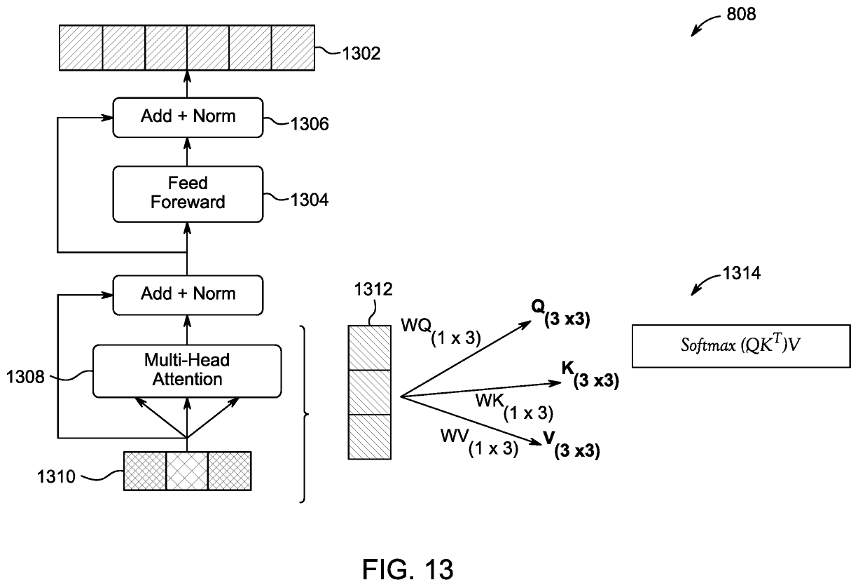

FIG. 13 illustrates a block diagram of a transformer architecture, in accordance with an example embodiment. The inputs 1310 is fed to a multi-head attention 1308 which refers to a mechanism that allows the model to focus on different parts of the input sequence simultaneously, attending to different relationships within the data. It is a key component of the transformer architecture helping in parallel processing.

Generally, in a transformer model, the input sequence is processed through multiple layers of self-attention or encoder-decoder attention. The self-attention mechanism enables the model to capture dependencies between different positions in the input sequence. Multi-head attention enhances this mechanism by performing self-attention multiple times in parallel, with each attention head attending to a different representation of the input. By employing multiple attention heads, the model can capture different types of information and learn diverse relationships within the input data. Each head can specialize in attending to different parts of the sequence, allowing the model to process and extract various patterns simultaneously. This parallelization and diversification of attention help the transformer model achieve better performance in capturing complex dependencies in sequential data.

The output of the multi-head attention 1308 is added to the inputs and normalized and forwarded to a reed forward layer 1304. In the context of a transformer, feed forward 1304 refers to a type of neural network layer that is applied independently to each position in the sequence. It is an essential component of the transformer architecture, working in conjunction with the self-attention mechanism to process and transform the input data.

The feed forward layer 1304 is applied independently to each position in the sequence, which means that the transformations are position-wise and do not take into account the relationships between different positions. This independence allows for parallelization and efficient processing of the input sequence.

The purpose of the feedforward layer in the transformer architecture is to introduce additional transformations and non-linearities to the self-attention outputs. While self-attention captures dependencies between different positions, the feedforward layer helps to model position-wise relationships and perform context-dependent transformations.

Further, the output of the feed forward layer is summed up 1306 with input to produce the output vector 1302.

In the context of a transformer, SoftMax 1314 refers to a mathematical function called the SoftMax function, which is commonly used to normalize a vector of values into a probability distribution. The SoftMax function is utilized in certain parts of the transformer model to convert scores or logits into probabilities.

In the self-attention mechanism of the transformer, attention weights are computed by applying the SoftMax function to the attention scores. These attention scores represent the relevance or importance of different positions in the input sequence. By using SoftMax, the scores are transformed into a probability distribution, ensuring that the weights sum up to 1 and can be interpreted as attention probabilities.

Given below is the SoftMax function.

Softmax(QK^{T})V 1314

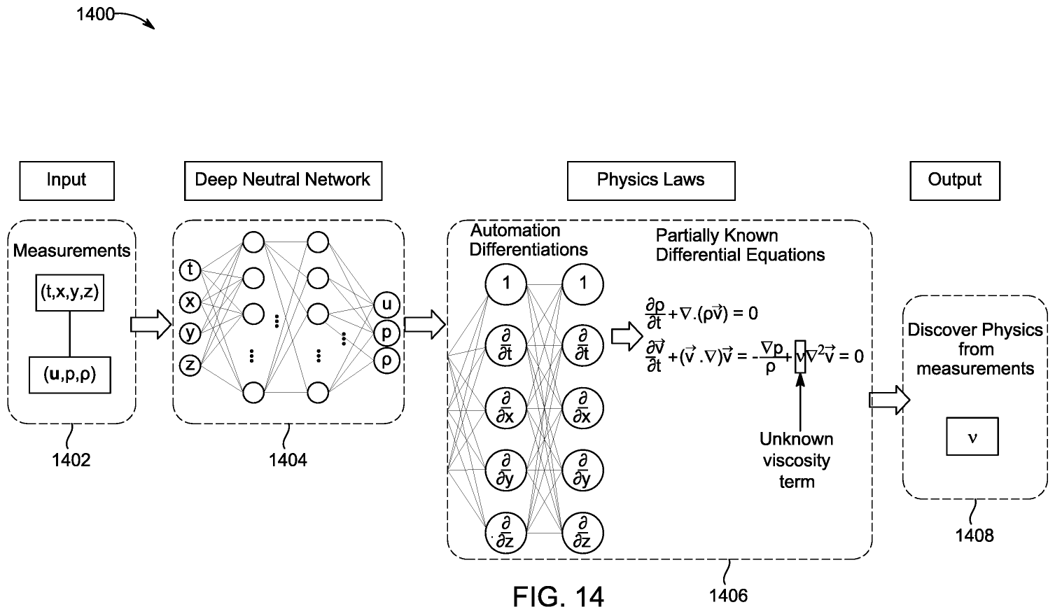

FIG. 14 illustrates a block diagram of a transformer boosted PINNs pertaining to inverse problem, in accordance with an example embodiment.

Generally, a Physics-Informed Neural Network (PINN) is a cutting-edge machine learning technique that combines the power of neural networks with the constraints imposed by physical laws or equations. It has gained considerable attention in solving inverse problems, which involve estimating the unknown parameters of a physical system given inputs and the observed outputs. PINNs offer a promising approach to tackle these challenging problems by seamlessly integrating the principles of physics and data-driven learning.

In an inverse problem, the first step involves collecting data from the physical system. These measurements might be noisy, incomplete, or correspond to a specific set of inputs and outputs. The goal is to estimate the unknown parameters that best explain the observed outputs for the given inputs. However, direct estimation can be difficult or even infeasible due to the complexity of the system or the limited amount of available data.

To overcome these challenges, a PINN leverages the power of neural networks to approximate the underlying physics or equations that govern the system. Neural networks are known for their ability to model complex relationships and capture intricate patterns in data. The network takes the inputs of the system as its input and predicts the corresponding outputs. In a PINN, the neural network is typically trained using supervised learning techniques, where known input-output pairs are used to optimize the network's parameters.

However, what sets PINNs apart is their ability to incorporate the knowledge of the physical laws or equations governing the system. The neural network is trained not only on observed data but also on the constraints imposed by physics. This is achieved by introducing loss terms that ensure the network satisfies the governing equations or physical laws. By incorporating these constraints during training, the PINN leverages the inherent structure of the problem and guides the neural network towards solutions that adhere to the physics of the system.

The training process of a PINN involves minimizing a combined loss function. This loss function comprises two essential components: a data loss term and a physics loss term. The data loss term quantifies the discrepancy between the predicted outputs and the observed outputs, thus driving the network to fit the available data. Simultaneously, the physics loss term enforces the physical constraints by measuring the deviation from the governing equations or constraints. Minimizing this term encourages the neural network to generate solutions that satisfy the underlying physics.

Through an iterative optimization process, such as gradient-based methods, the neural network parameters are optimized to minimize the combined loss function. During this process, the neural network learns to approximate the forward model while satisfying the physical constraints. This integration of data-driven learning and physics-based constraints enables the PINN to capture complex patterns and relationships within the data while respecting the underlying physics of the system.

Once the PINN is trained, it can be utilized to solve the inverse problem. Given the observed outputs for a set of inputs, the PINN predicts the corresponding parameters that best explain the data. By leveraging the learned relationships between inputs and outputs, as well as the incorporated physical constraints, the PINN provides an estimate of the unknown parameters of the physical system.

In an embodiment, the inputs 1402 are temporal and spatial components are fed to a deep neural network 1404 to obtain a first output at the block 1404 which is velocity, pressure, and density. The first output is fed to the physics layer 1406 which contains an unknown term to produce a second output 1408 which is the unknown term. In summary, Physics-Informed Neural Networks (PINNs) offer a powerful approach to solving inverse problems. By combining the flexibility and modeling capabilities of neural networks with the incorporation of physical constraints, PINNs enable accurate estimation of unknown parameters from observed outputs for a set of inputs. They leverage the strengths of data-driven learning while ensuring that the estimated solutions adhere to the underlying physics or governing equations. PINNs have the potential to revolutionize the field of inverse problems by offering efficient and accurate solutions in complex and challenging scenarios. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

What is claimed is:

1. A system for augmenting a neural network comprising:
the neural network further comprising:
an input layer;
a hidden layer connected to the input layer; and
an output layer joined to the hidden layer;
a layer for computing physics equations connected to the output layer;
a pre-input layer attached to the input layer comprising:
a first encoder for handling spatial inputs; and
a second encoder for handling temporal inputs.

2. The system of claim 1, wherein the neural network is an unsupervised learning neural network.

3. The system of claim 1, wherein pre-input layer is a transformer.

4. The system of claim 1, wherein the first encoder is concatenated to the second encoder

5. The system of claim 1, wherein the system further comprising, computing the physics equation iteratively.

6. The system of claim of claim 1, wherein the physics equations comprise at least a partial differential equation.

7. The system of claim 1, wherein the pre-input layer is a RNN.

8. The system of claim 1, wherein the pre-input layer is a LSTM.

9. The system of claim 1, further comprising processing data input to the input layer parallelly.

10. A computer-implemented method for augmenting a neural network comprising:
connecting an input layer to a pre-input layer;
joining a hidden layer to the input layer;
linking an output layer to the hidden layer; and
connecting a layer for computing physics equations to the output layer.

11. The computer-implemented method of claim 10, wherein the neural network is an unsupervised learning neural network.

12. The computer-implemented method of claim 10, wherein the pre-input layer is a transformer layer comprises encoders.

13. The computer-implemented method of claim 12, wherein the encoders further comprising a first encoder to handle time inputs.

14. The computer-implemented method of claim 12 wherein the encoders further comprising a second encoder to handle space inputs.

15. The computer-implemented method of claim 10, wherein the physics equations comprise at least a partial differential equation.

16. The computer-implemented method of claim 10, wherein the pre-input layer is a RNN.

17. The computer-implemented method of claim 10, wherein the pre-input layer is a LSTM.

18. The computer-implemented method of claim 10, further comprising processing data input to the input layer parallelly.

19. A non-transitory computer-readable storage medium having stored thereon computer executable instruction which when executed by one or more processors, cause the one or more processors to carry out operations for augmenting a neural network comprising, the operations comprising perform the operations comprising:
connecting an input layer to a pre-input layer;
joining a hidden layer to the input layer;
linking an output layer to the hidden layer; and
connecting a layer for computing physics equations to the output layer.
